(19) United States
(12) Patent Application Publication
(10) Pub. No.: US 2024/0177896 A1
(43) Pub. Date: May 30, 2024

(54) FERRITE SINTERED MAGNET AND MANUFACTURING METHOD THEREFOR

(71) Applicant: TDK CORPORATION, Tokyo (JP)

(72) Inventors: Shogo MUROYA, Tokyo (JP); Yoshitaka MURAKAWA, Tokyo (JP); Hiroyuki MORITA, Tokyo (JP); Masanori IKEDA, Tokyo (JP); Takuma ABE, Tokyo (JP)

(73) Assignee: TDK CORPORATION, Tokyo (JP)

(21) Appl. No.: 18/283,739

(22) PCT Filed: Mar. 24, 2022
(86) PCT No.: PCT/JP2022/014013

§ 371 Date: Sep. 22, 2023

(30) Foreign Application Priority Data
Mar. 25, 2021 (JP) 2021-052090

(51) Int. Cl. H01F 1/03; H01F 1/11

(52) U.S. Cl. CPC H01F 1/0315; H01F 1/11

(57) ABSTRACT

A ferrite sintered magnet represented by A₁₋ₓRₓ(Fe_{12-y}Co_{y})_{z}O₁₉ in terms of atomic number ratio. A is at least one selected from a group made of Sr, Ba and Pb. R is La only or La and at least one selected from a group made of Bi and rare earth elements. 0.14≤x≤0.22, 11.60≤(12−y)×z≤11.99, and 0.13≤y×z≤0.17 are satisfied. 0.500≤Mc≤0.710 is satisfied in which Mc is CaO content in mass % converted from a content of Ca included in the ferrite sintered magnet. 0.410≤Ms≤0.485 is satisfied in which Ms is SiO₂ content in mass % converted from a content of Si included in the ferrite sintered magnet.

### BACKGROUND OF THE INVENTION

The invention relates to a ferrite sintered magnet and a manufacturing method therefor.

In order to obtain a ferrite sintered magnet having excellent magnetic properties, a high residual magnetic flux density Br or a high coercive force HcJ, it is known to use an Sr ferrite which is a hexagonal M-type ferrite containing at least strontium Sr.

Patent Document 1 discloses Sr ferrite which contains at least lanthanum La as a rare earth element, and replaces a part of iron Fe with cobalt Co. By using the Sr ferrite containing lanthanum La and cobalt Co as essential elements, a ferrite sintered magnet with high residual magnetic flux density Br, high coercive force HcJ and improved temperature properties of HcJ can be obtained.

Patent Document 1: Japanese unexamined patent publication H11-246223

### BRIEF SUMMARY OF INVENTION

An object of the invention is to obtain a ferrite sintered magnet that is excellent in magnetic properties and has preferable production stability even when it is thin.

A ferrite sintered magnet represented by A₁₋ₓRₓ(Fe_{12-y}Co_{y})_{z}O₁₉ in terms of atomic number ratio, in which
A is at least one selected from a group consisting of Sr, Ba and Pb,
R is La only or La and at least one selected from a group consisting of Bi and rare earth elements,
0.14≤x≤0.22,
11.60≤(12−y)×z≤11.99, and
0.13≤y×z≤0.17 are satisfied;
0.500≤Mc≤0.710 is satisfied in which Mc is CaO content in mass % converted from a content of Ca included in the ferrite sintered magnet, and
0.410≤Ms≤0.485 is satisfied in which Ms is SiO₂ content in mass % converted from a content of Si included in the ferrite sintered magnet.

The ferrite sintered magnet may satisfy 0.500≤Mc≤0.700 and 0.420≤Ms≤0.475.

The ferrite sintered magnet may have an average thickness of 3.2 mm or less.

The ferrite sintered magnet may satisfy 0.410≤Ms≤0.450.

The ferrite sintered magnet may have an average thickness of 3.3 mm or more and 6.5 mm or less.

The ferrite sintered magnet may satisfy 0≤Mb≤0.150 in which Mb is BaO content in mass % converted from a content of Ba included in the ferrite sintered magnet.

The ferrite sintered magnet may satisfy 0≤Ma≤0.900 in which Ma is Al₂O₃ content in mass % converted from a content of Al included in the ferrite sintered magnet.

The ferrite sintered magnet may satisfy 0≤Mr≤0.100 in which Mr is Cr₂O₃ content in mass % converted from a content of Cr included in the ferrite sintered magnet.

The ferrite sintered magnet may be obtained by firing a green compact having an average thickness of 3.5 mm or more and 8.0 mm or less.

A manufacturing method of the ferrite sintered magnet including a firing process of the green compact having an average thickness of 3.5 mm or more and 8.0 mm or less.

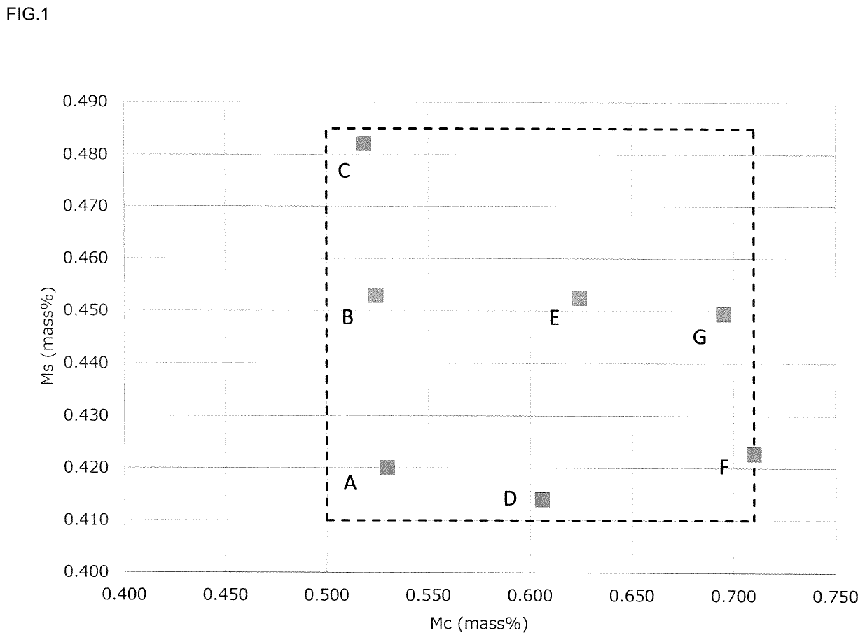

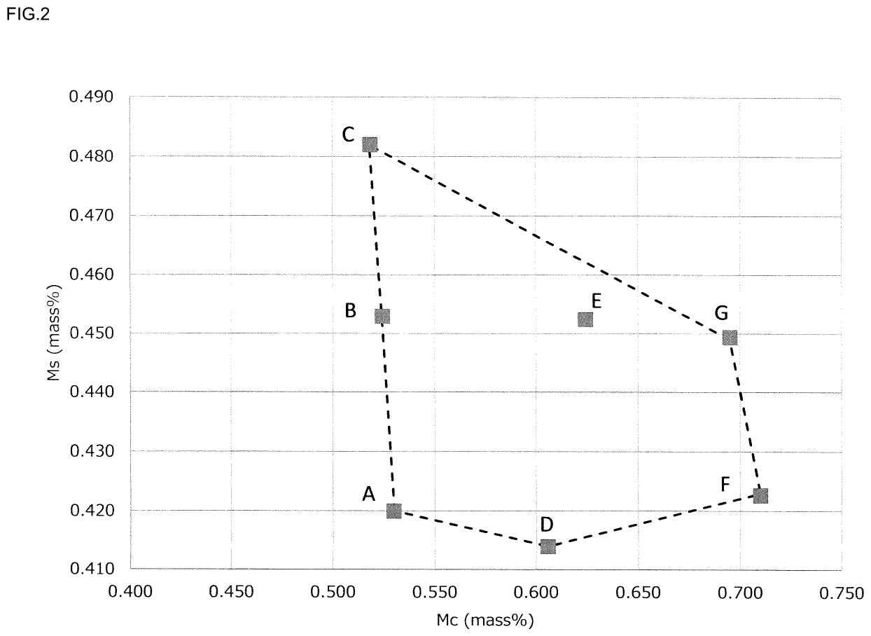

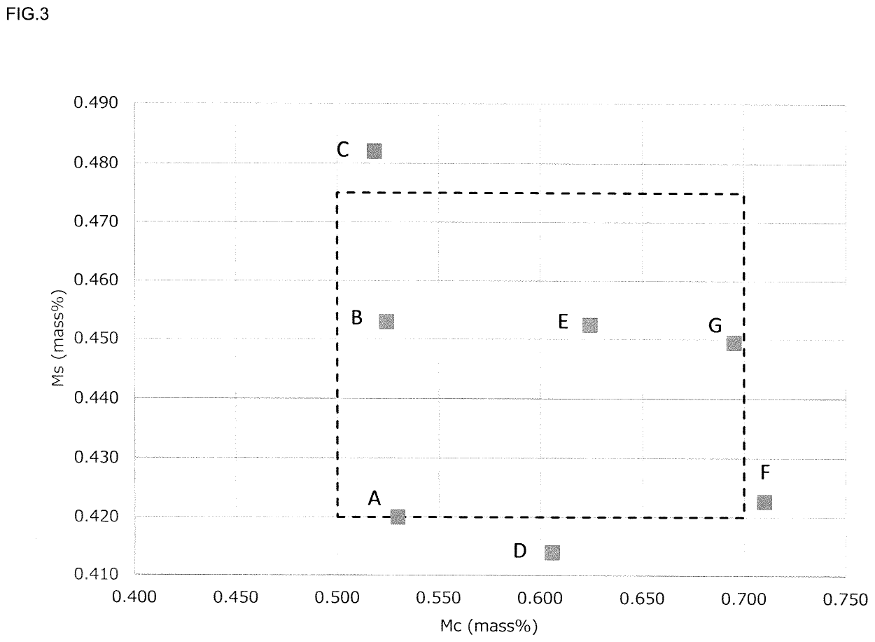

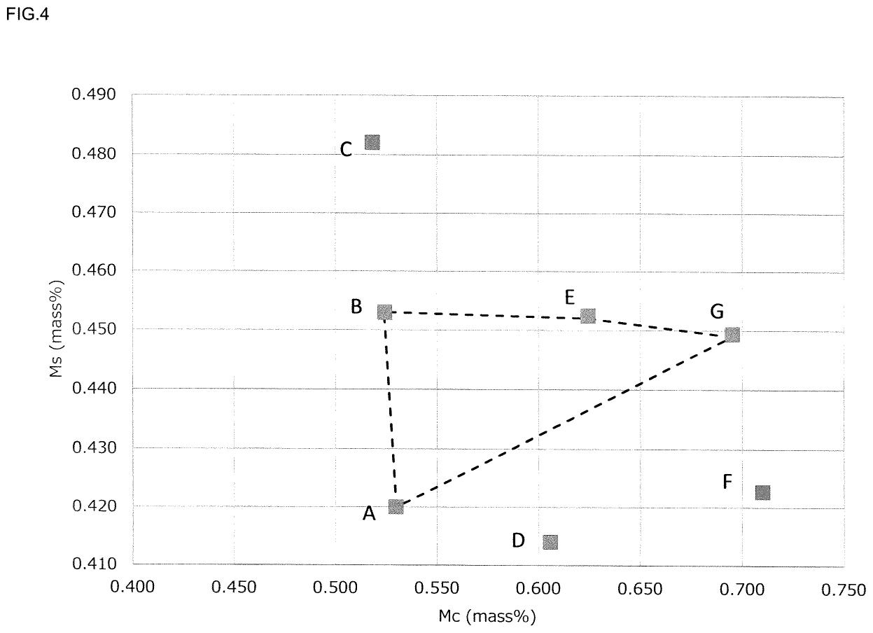

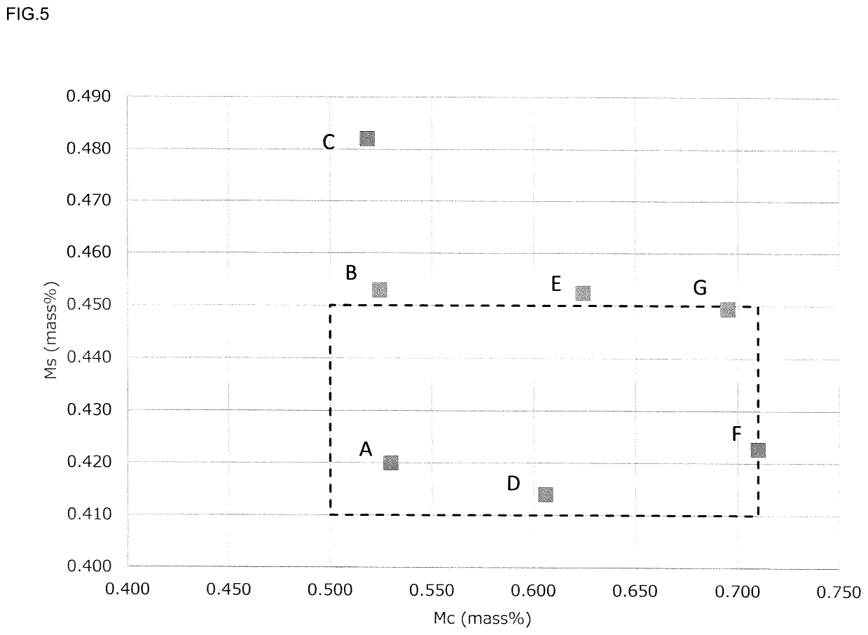

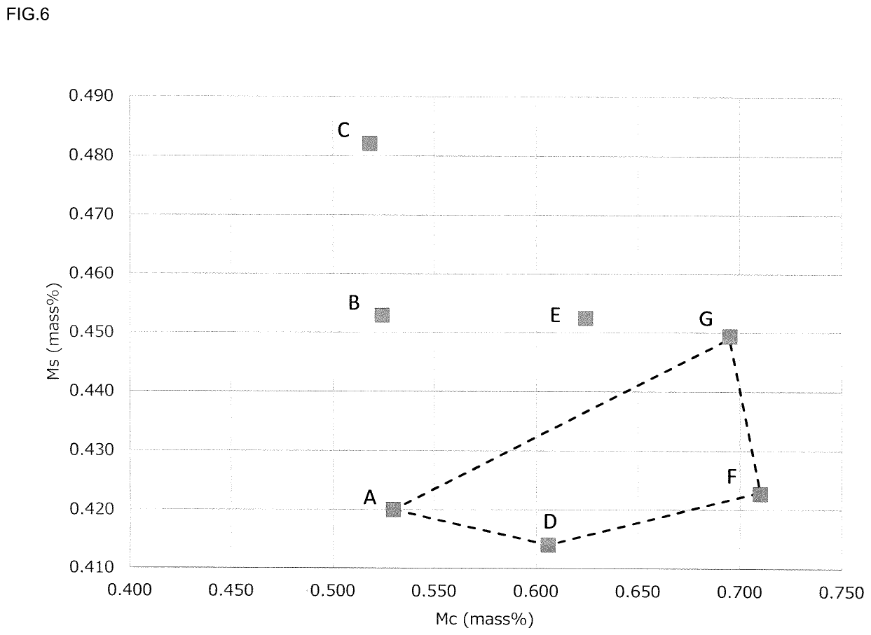

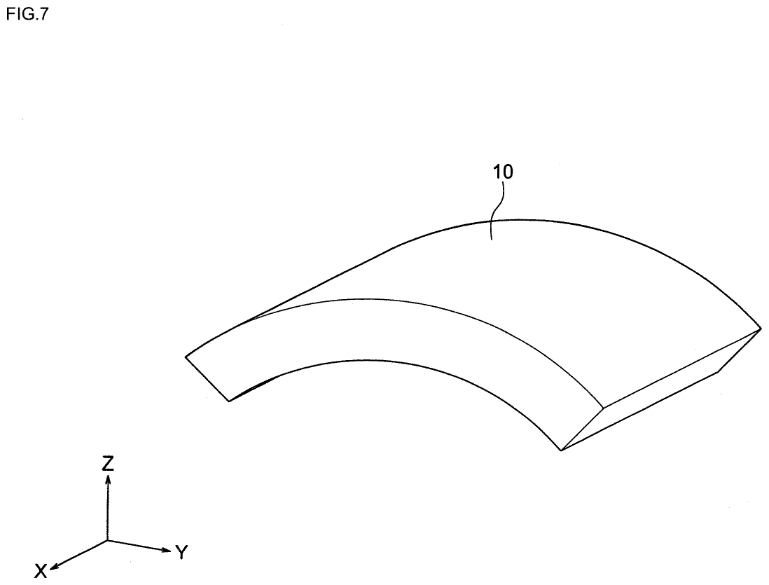

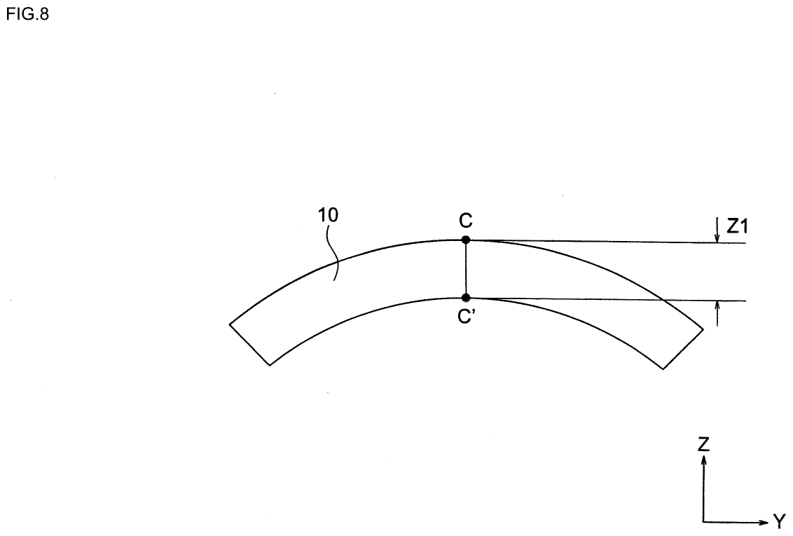

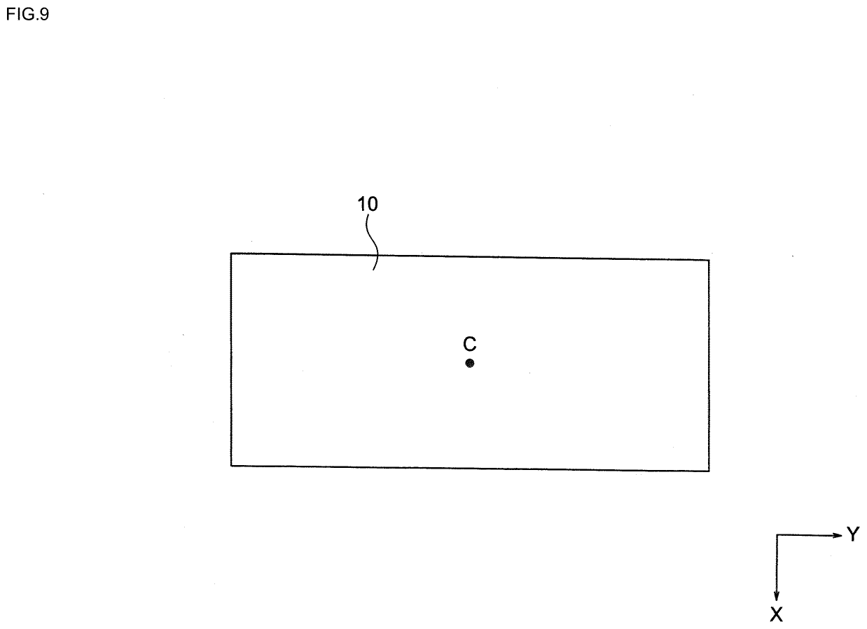

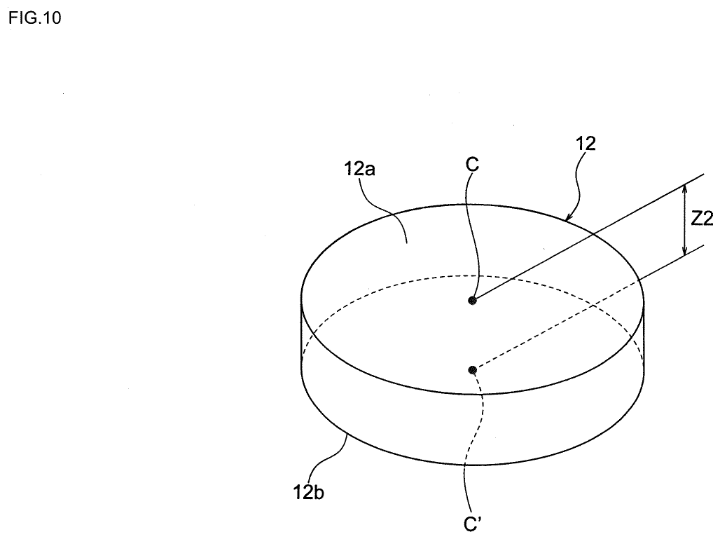

### BRIEF DESCRIPTION OF THE DRAWINGS

[FIG. 1] is a graph showing the relationship between Mc and Ms at which the production stabilities are high for a green compact having any of the thicknesses of 3.5 to 8.0 mm.

[FIG. 2] is a graph showing the relationship between Mc and Ms at which the production stabilities are high for the green compact having any of the thicknesses 3.5 to 8.0 mm.

[FIG. 3] is a graph showing the relationship between Mc and Ms at which the production stabilities are high for the green compact having the thicknesses 3.5 to 4.0 mm.

[FIG. 4] is a graph showing the relationship between Mc and Ms at which the production stabilities are high for the green compact having the thicknesses 3.5 to 4.0 mm.

[FIG. 5] is a graph showing the relationship between Mc and Ms at which the production stabilities are high for the green compact having the thicknesses 5.5 to 8.0 mm.

[FIG. 6] is a graph showing the relationship between Mc and Ms at which the production stabilities are high for the green compact having the thicknesses 5.5 to 8.0 mm.

[FIG. 7] is a schematic view of a C-shaped green compact.

[FIG. 8] is FIG. 7 viewed from the X-axis positive direction.

[FIG. 9] is FIG. 7 viewed from the Z-axis positive direction.

[FIG. 10] is a schematic view of a cylindrical green compact.

### DETAILED DESCRIPTION OF INVENTION

Hereinafter, the invention will be described in detail based on embodiments.

The ferrite sintered magnet according to the embodiment is the ferrite sintered magnet represented by A₁₋ₓRₓ(Fe_{12-y}Co_{y})_{z}O₁₉ in terms of atomic number ratio. In this specification, the ferrite sintered magnet according to the embodiment may be simply referred to as the ferrite sintered magnet.

A is at least one selected from a group consisting of Sr, barium Ba and lead Pb.

R is La only or La and at least one selected from a group consisting of Bi and rare earth elements, and
“x”, “(12−y)×z”, and “y×z” satisfy the following formulas:

0.14≤x≤0.22,

11.60≤(12−y)×z≤11.99, and

0.13≤y×z≤0.17.

In the following description, (12−y)×z is sometimes simply referred to as (12−y)z. Sometimes y×z is simply referred to as yz.
0.500≤Mc≤0.710 is satisfied in which Mc is a CaO content (mass %) converted from the content of Ca included in the ferrite sintered magnet, and
0.410≤Ms≤0.485 is satisfied in which Ms is a SiO₂ content (mass %) converted from the content of Si included in the ferrite sintered magnet.

The ferrite sintered magnet has a hexagonal M-type ferrite represented by A₁₋ₓRₓ(Fe_{12-y}Co_{y})_{z}O₁₉ in terms of atomic number ratio.

Specifically, the ferrite sintered magnet contains ferrite particles represented by A₁₋ₓRₓ(Fe_{12-y}Co_{y})_{z}O₁₉ in terms of atomic number ratio. Ferrite particles are crystal particles and have a hexagonal magnetoplumbite crystal structure. It can be confirmed by such as X-ray structure diffraction that the ferrite particles have a hexagonal magnetoplumbite crystal structure.

The ferrite sintered magnet has a small Co content yz. Less excess Co is contained in the ferrite sintered magnet, and thus, the generation of heterogeneous phases is suppressed and a uniform fine structure is formed. As a result, the ferrite sintered magnet has high Br and high HcJ. By controlling the Ca content and the Si content in the ferrite sintered magnet, changes in particle growth with respect to changes in firing temperature are reduced. This improves the production stability of the ferrite sintered magnet. Furthermore, the ferrite sintered magnet can be produced at a low cost due to the small Co content yz.

“A” is at least one selected from a group consisting of Sr, Ba and Pb. The content ratio of Sr in “A” may be 90 at % or more, or “A” may be Sr alone. The content ratio of Ba in “A” may be one at % or less.

“R” is at least one selected from rare earth elements, and “R” contains at least La. The content ratio of La in “R” may be 90 at % or more, or “R” may be La alone.

Br and the production stability will decrease when “x” is too small, while HeJ and the production stability will decrease when “x” is too large. In addition, it is preferable to satisfy 0.16≤x≤0.20, and it is more preferable to satisfy 0.18≤x≤0.19. High production stability means small changes in magnetic properties, especially HcJ, even when the firing temperature changes.

HcJ and the production stability will decrease when (12−y)z is too small, while Br and/or HcJ will decrease and the production stability also tends to decrease when (12−y)z is too large. In addition, it is preferable to satisfy 11.66≤(12−y)z≤11.99, and it is more preferable to satisfy 11.83≤(12−y)z≤11.99.

HcJ and the production stability will decrease when yz is too small, while Br decreases and the cost will increase when yz is too large. In addition, it is preferable to satisfy 0.14≤yz≤0.17.

Here, the inventors have found that the thickness of the green compact before firing for obtaining the ferrite sintered magnet varies the composition that improves the production stability, particularly Mc and Ms that improve the production stability. When Mc and Ms are 0.500≤Mc≤0.710 and 0.410≤Ms≤0.485, respectively, the production stability is particularly preferable for the green compact with thicknesses ranging from 3.5 to 8.0 mm. In other words, it is possible to achieve particularly preferable production stability even when the thickness of the green compact is small.

FIG. 1 is a graph in which Mc and Ms are 0.500≤Mc≤0.710 and 0.410≤Ms≤0.485. In FIG. 1, the horizontal axis is Mc and the vertical axis is Ms. When the point (Mc, Ms) is within the range surrounded by the dotted line. 0.500≤Mc≤0.710 and 0.410≤Ms≤0.485 are satisfied. And when Mc and Ms are 0.500≤Mc≤0.710 and 0.410≤Ms≤0.485, the production stability can be enhanced for the green compact with thicknesses ranging from 3.5 to 8.0 mm.

Furthermore, the relationship between Mc and Ms may be within the range bounded by six points, A (0.530, 0.420), B (0.524, 0.453), C (0.518, 0.482), D (0.606, 0.414), F (0.710, 0.423) and G (0.695, 0.449), shown in FIG. 2.

When the green compact has a thickness ranging from 3.5 to 8.0 mm, the thickness of the sintered body, the ferrite sintered magnet, becomes approximately 2.5 to 6.5 mm unless the processing described later is performed. However, the surface of the sintered body can be processed, such as polished, and the thickness of the sintered body can be further reduced by processing. Considering the above, the thickness of the sintered body, the ferrite sintered magnet, may be 6.5 mm or less, or may be 2.0 mm or more and 6.5 mm or less. In particular, the thickness of the sintered body, the ferrite sintered magnet, after processing may be 5.5 mm or less, or may be 2.0 mm or more and 5.5 mm or less.

“Thickness” in the specification refers to an average thickness. There is no particular limitation on the method for measuring the average thickness. When the two planes perpendicular to the thickness direction of the green compact or the sintered body are parallel or substantially parallel, the thickness at any one point may be measured and determined as the average thickness. If the two planes perpendicular to the thickness direction of the green compact or the sintered body are not substantially parallel, the measurement may be performed by a well-known method according to the shape of the green compact or the sintered body.

For example, in the case of the C-shaped green compact 10 shown in FIG. 7, the distance Z1 between points C and C′ shown in FIG. 8, which is FIG. 7 viewed from the X-axis positive direction, is assumed to be the thickness of the C-shaped green compact 10. When a straight line is drawn in the y-axis direction from the points C and C′, the straight line becomes a straight line that is in contact with the curved surface of the C-shaped green compact 10. As shown in FIG. 9, which is FIG. 7 viewed from the positive direction of the z-axis direction, the position of the point C in the C-shaped green compact 10 is the central part of the plane viewed from the positive direction of the z-axis. The above explanation also applies to the C-shaped sintered body.

For example, in the case of the disk-shaped green compact 12 shown in FIG. 10, the thickness of the disk-shaped green compact 12 may be the distance Z2 between the point C and the point C′ shown in FIG. 10. The point C is the center of the upper surface 12a. A straight line perpendicular to the lower surface 12b is drawn from the point C, and the intersection of the straight line and the lower surface 12b is a point C′. The point C′ is the center of the lower surface 12b. The above explanation also applies to the disk-shaped sintered body.

It is preferable that the production stability is always high particularly when the thickness of the green compact is 3.5 to 4.0 mm. In order to always improve production stability with the thickness within this range, it is preferable to satisfy 0.500≤Mc≤0.700 and 0.420≤Ms≤0.475. FIG. 3 is a graph showing 0.500≤Mc≤0.700 and 0.420≤Ms≤0.475. 0.500≤Mc≤0.700 and 0.420≤Ms≤0.475 are satisfied when the point (Mc, Ms) is within the range enclosed by the dotted line.

When the green compact has a thickness ranging from 3.5 to 4.0 mm, the thickness of the sintered body, the ferrite sintered magnet, becomes approximately 2.5 to 3.2 mm unless the processing described later is performed. However, the surface of the sintered body can be processed, such as polished, and the thickness of the sintered body can be further reduced by processing. Considering above, the thickness of the sintered body, the ferrite sintered magnet, may be 3.2 mm or less, or may be 2.0 mm or more and 3.2 mm or less. In particular, the thickness of the sintered body, the ferrite sintered magnet, after processing may be less than 3.0 mm, or may be 2.0 mm or more and less than 3.0 mm.

Furthermore, the point (Mc, Ms) may be within the range bounded by four points, A (0.530, 0.420), B (0.524, 0.453), E (0.624, 0.452) and G (0.695, 0.449), indicated by the dotted line in FIG. 4.

When the thickness of the green compact is ranging from 5.5 to 8.0 mm, the production stability may always be high. In order to always improve production stability with a thickness within this range, it is preferable to satisfy 0.500≤Mc≤0.710 and 0.410≤Ms≤0.450. FIG. 5 is a graph in which Mc and Ms are 0.500≤Mc≤0.710 and 0.410≤Ms≤0.450. 0.500≤Mc≤0.710 and 0.410≤Ms≤0.450 are satisfied when the point (Mc, Ms) is within the range enclosed by the dotted line.

When the green compact has a thickness of 5.5 to 8.0 mm, the thickness of the sintered body, the ferrite sintered magnet, becomes approximately 4.0 to 6.5 mm unless the processing described later is performed. However, the surface of the sintered body can be processed, such as polished, and the thickness of the sintered body can be further reduced by processing. Considering the above, the thickness of the sintered body, the ferrite sintered magnet, may be 6.5 mm or less, or may be 3.3 mm or more and 6.5 mm or less. In particular, the thickness of the sintered body, the ferrite sintered magnet, after processing may be 5.5 mm or less, or may be 3.3 mm or more and 5.5 mm or less.

Furthermore, the point (Mc, Ms) may be within the range bounded by four points, A (0.530, 0.420), D (0.606, 0.414), F (0.710, 0.423) and G (0.695, 0.449), indicated by the dotted line in FIG. 6.

The ferrite sintered magnet may contain Ba. It may satisfy 0≤Mb≤0.150, 0.030≤Mb≤0.150 or 0.030≤Mb≤0.101, in which Mb is BaO content (mass %) converted from the content of Ba included in the ferrite sintered magnet.

Br tends to decrease when BaO content is excessively high. In particular, when 0.030≤Mb≤0.101 is satisfied, Br tends to be improved while maintaining preferable HcJ and the production stability even the thickness of the green compact is thin.

Ba may be contained in the ferrite sintered magnet as “A” in A₁₋ₓRₓ(Fe_{12-y}Co_{y})_{z}O₁₉, a Ba compound other than A₁₋ₓRₓ(Fe_{12-y}Co_{y})_{z}O₁₉, or a simple substance of Ba.

The ferrite sintered magnet may contain aluminum Al. It may satisfy 0≤Ma≤0.900, 0.060≤Ma≤0.900, or 0.060≤Ma≤0.360 in which Ma is a Al₂O₃ content (mass %) converted from the content of Al included in the ferrite sintered magnet.

Br tends to decrease as Al₂O₃ content is excessively high. HcJ tends to decrease as Al₂O₃ content decreases. In particular, Br, HcJ, and the production stability tend to be maintained in preferable conditions even the thickness of the compact is thin when 0.060≤Ma≤0.900 is satisfied. In addition, it particularly becomes easy to maintain Br in preferable condition when 0.060≤Ma≤0.360 is satisfied.

The ferrite sintered magnet may contain chromium Cr. It may satisfy 0≤Mr≤0.100, 0.030≤Mr≤0.100, or 0.030≤Mr≤0.061 in which Mr is a Cr₂O₃ content (mass %) converted from the content of Cr included in the ferrite sintered magnet.

Br tends to decrease when Cr₂O₃ content is excessively high. HcJ tends to decrease as Cr₂O₃ content decreases. Br, HcJ, and the production stability tend to be maintained in preferable conditions even the thickness of the green compact is thin when 0.030≤Mr≤0.100 is satisfied. In addition, it particularly becomes easy to maintain Br in preferable condition when 0.030≤Mr≤0.061 is satisfied.

The ferrite sintered magnet may contain manganese Mn, magnesium Mg, copper Cu, nickel Ni and/or zinc Zn as impurities. Contained amounts of these impurities are not particularly limited, but each of these impurities may be contained in an amount of 0.5 mass % or less based on 100 mass % of the entire ferrite sintered magnet. In addition, these impurities may be contained in a total amount of 0.7 mass % or less. Note that these impurities may be intentionally added.

The ferrite sintered magnet may further contain elements other than the above elements, specifically other than the elements A, R, Fe, Co, O, Ca, Si, Al, Cr, Mn, Mg, Cu, Ni and Zn, as inevitable impurities. The inevitable impurities may be contained in a total amount of 3 mass % or less based on 100 mass % of the entire ferrite sintered magnet.

A calculation method of Mc will be described below. The calculation methods of Ms. Mb, Ma, and Mr are also the same.

First, the Ca content contained in the ferrite sintered magnet is measured by a usual method in this technical field. Then, the content of Ca is converted to a content of CaO oxide. The contents of the above elements other than “O” contained in the ferrite sintered magnet, specifically, each content of A, R, Fe, Co, Ca, Si, Ba, Al, Cr, Mn, Mg, Cu, Ni, and Zn is measured in a similar manner and then converted to a content of oxides, respectively. Specifically, the elements are respectfully converted to a content of AO, R₂O₃, Fe₂O₃, Co₃O₄, CaO, SiO₂, BaO, Al₂O₃, Cr₂O₃, MnO, MgO, CuO, NiO, and ZnO. Furthermore, the contents of inevitable impurities are similarly measured and appropriately converted to the contents of oxides.

Mc can then be calculated by dividing the CaO content by the total content of all the above oxides. That is, when calculating Mc and the like, the total content of all the above oxides is regarded as the mass of the entire ferrite sintered magnet.

There is no particular limitation on the density of the ferrite sintered magnet. For example, the density measured by the Archimedes method may be 4.9 g/cm³ or more and 5.2 g/cm³ or less. Br tends to be preferable when the density is within the above range, particularly 5.0 g/cm³ or more.

Hereinafter, a manufacturing method of the ferrite sintered magnet according to the embodiment will be described.

The following embodiment shows an example method for the ferrite sintered magnet. In the embodiment, the ferrite sintered magnet can be produced through a blending process, a calcining process, a pulverizing process, a compacting process and a firing process. Each process will be described below.

### <Blending Process>

In the blending process, raw materials for the ferrite sintered magnet are blended to obtain a raw material mixture. Materials for the ferrite sintered magnets include compounds, raw material compounds, containing one or more of the constituent elements. The raw material compound is preferably in powder form and the like.

Examples of raw material compounds include oxides of respective elements, and compounds that become oxides upon firing such as carbonates, hydroxides, nitrates, etc. SrCO₃, BaCO₃, PbCO₃, La₂O₃, Fe₂O₃, Co₃O₄, CaCO₃, SiO₂, Al₂O₃, Cr₂O₃, MnO, MgO, NiO, CuO, ZnO, etc., can be exemplified. The average particle size of the raw material compound powder may be about 0.1 μm to 2.0 μm.

For the blending, for example, each raw material is weighed so as to obtain a desired composition of the ferrite magnetic material. Then, the raw materials may be mixed and pulverized for about 0.1 hour to 20 hours using a wet attritor, a ball mill or the like. In this blending process, it is not necessary to mix all the raw materials, and some of them may be added after calcining, which will be described later.

### <Preliminary Firing Process>

In the preliminary firing process, the raw material mixture obtained in the blending process is preliminary fired. Preliminary firing can be performed, for example, in an oxidizing atmosphere such as air. The preliminary firing temperature is preferably in the temperature range of 1100° C.to 1300° C. The preliminary firing time may be one second to 10 hours.

The primary particle size of the preliminary fired body obtained by preliminary firing may be 10 μm or less.

### <Pulverizing Process>

In the pulverizing process, the preliminary fired body that has become granular or clumpy in the preliminary firing process is pulverized into powder. This facilitates compacting in the compacting process described later. As described above, raw materials that were not blended in the blending process may be added in the pulverizing process, i.e. post-addition of raw materials. The pulverizing process may be carried out, for example, in a two-stage process in which the preliminary fired body is pulverized (coarse pulverization, crush) into a coarse powder, and then further finely pulverized (fine pulverization).

Coarse pulverization is carried out using a vibrating mill or the like until the average particle size reaches 0.5 μm to 10.0 μm. In fine pulverization. the coarsely pulverized material obtained by the coarse pulverization is further pulverized by a wet attritor, ball mill, jet mill, or the like.

Fine pulverization is carried out so that the average particle size of the obtained finely pulverized material is preferably about 0.08 μm to 1.00 μm. The specific surface area of the finely pulverized material determined by the BET method and the like may be about 4 m²/g to 12 m²/g. The pulverization time varies depending on the pulverization method. For example, in the case of a wet attritor, it can be about 30 minutes to 20 hours, and in the case of wet pulverization by a ball mill, it can be about 1 hour to 50 hours. The longer the pulverization time for fine pulverization, the more likely the production stability is improved, however, the higher the production cost.

In the fine pulverization process, in the case of the wet method, a non-aqueous solvent such as toluene and xylene in addition to an aqueous solvent such as water may be used as a dispersion medium. The use of the non-aqueous solvent tends to provide a high degree of orientation during a wet pressing, which is described below. On the other hand, the use of an aqueous solvent such as water is advantageous in terms of productivity.

In the pulverization process, such as a known polyhydric alcohol or dispersant may be added in order to increase the degree of orientation of the sintered body obtained after firing.

### <Compacting/Firing Process>

In the compacting/firing process, the pulverized material, preferably finely pulverized material, obtained after the pulverizing process is compacted to obtain a green compact, and then the green compact is fired and sintered. The compacting can be carried out by a dry pressing, a wet pressing or Ceramic Injection Molding (CIM). When the composition is within the above range, a ferrite sintered magnet having preferable magnetic properties and production stability can be obtained even when the green compact is as thin as 8.0 mm or less.

In the dry pressing method, for example, the green compact is formed by applying a magnetic field while pressing dry magnetic powder, and then firing the green compact. In general, the dry pressing method has an advantage that the time required for the pressing process is short because the dried magnetic powder is pressed in a press mold.

In the wet pressing method, for example, a green compact is formed by removing a liquid component while pressing a slurry containing magnetic powder while applying a magnetic field, and then firing the green compact. The wet pressing method has the advantage that the magnetic powder is easily oriented by the magnetic field when pressing, and the magnetic properties of the sintered magnet are preferable.

In the compacting method using CIM, dried magnetic powder is heated and kneaded with a binder resin, and the formed pellets are injection-molded in a mold to which the magnetic field is applied to obtain a preliminary green compact. The preliminary green compact is then fired after a binder removal treatment.

Hereinafter, the wet pressing method will be described in detail.

### <Wet Pressing/Firing>

When a ferrite sintered magnet is obtained by a wet pressing method, slurry is obtained by carrying out the fine pulverization process described above in a wet process. This slurry is concentrated to a predetermined concentration to obtain a slurry for wet pressing. Pressing can be performed using thereof.

Concentration of the slurry can be carried out by centrifugation, filter press, or the like. Content of the finely pulverized material in the slurry for wet pressing may be about 30 wt % to 80 wt % in the total amount of the slurry for wet pressing.

In the slurry, water may be used as the dispersion medium for dispersing the finely pulverized material. In this case, a surfactant such as gluconic acid, gluconate, or sorbitol may be added to the slurry. Moreover, the non-aqueous solvent may be used as the dispersion medium. Organic solvents such as toluene and xylene may be used as the non-aqueous solvent. In this case, a surfactant such as oleic acid may be added.

The slurry for wet pressing may be prepared by adding the dispersion medium or the like to the finely pulverized material in a dry state after the fine pulverization.

In the wet pressing, the slurry for wet pressing is then compacted in a magnetic field. In that case, pressure of the pressing may be about 9.8 MPa to 98 MPa (0.1 ton/cm² to 1.0 ton/cm²). The applied magnetic field may be about 400 kA/m to 1600 kA/m. In addition, the pressurizing direction and the magnetic field application direction during pressing may be in the same direction or in mutually orthogonal directions.

Firing of the green compact obtained by the wet pressing may be carried out in an oxidizing atmosphere such as the atmosphere. The firing temperature may be between 1050° C. and 1270° C. Also, the firing time, the time during which the firing temperature is maintained, may be about 0.5 to 3 hours. Then, a ferrite sintered magnet is obtained by firing.

When the green compact is obtained by the wet pressing, it can be heated from room temperature to around 100° C. at a temperature rising rate of about 2.5° C./min before reaching the firing temperature. By sufficiently drying the green compact, the occurrence of cracks may be suppressed.

Further, when a surfactant (dispersant) or the like is added, heating is performed at a temperature rising rate of about 2.0° C./min in a temperature range of about 100° C. to 500° C., and these may sufficiently remove the surfactant (degreasing treatment). These treatments may be performed at the beginning of the firing process, or may be performed separately prior to the firing process.

The thickness of the ferrite sintered magnet after firing is generally smaller than the thickness of the green compact before firing. The thickness of the ferrite sintered magnet is around 73 to 80% of the thickness of the green compact before firing.

In addition, the shape of the ferrite sintered magnet may be processed. The processing method is not particularly limited, but examples include polishing the surfaces, particularly two surfaces perpendicular to the thickness direction. When the surface is polished, each surface may be polished by a maximum of about 25% of the thickness of the sintered body, or each surface may be polished by about 13 to 20%. Excessive polishing increases the loss of material and increases the manufacturing cost. Further, although thin ferrite sintered magnets can be produced by dividing a thick ferrite sintered magnet vertically in the thickness direction, the manufacturing cost increases when number of steps for dividing the ferrite sintered magnet increases.

A preferred manufacturing method for a ferrite sintered magnet has been described above, but the manufacturing method is not limited thereto, and the manufacturing conditions and the like may be suitably changed.

The shape of the ferrite sintered magnet of the invention is not limited as long as it has the ferrite composition of the invention. For example, the ferrite sintered magnets may have various shapes such as an anisotropic arc segment shape, a flat plate shape, a cylindrical shape, and a columnar shape. According to the ferrite sintered magnet of the invention, a high Br can be obtained while maintaining a high HcJ regardless of the shape of the magnet. In addition, the ferrite sintered magnet of the invention has preferable production stability.

The use of the ferrite sintered magnet obtained by the invention is not particularly limited, but it can be used in rotary electric machines and the like. Also, a rotating electrical machine obtained by the invention has the above ferrite sintered magnet. There is no particular limitation on types of the rotating electric machines. Examples include motors and generators.

### EXAMPLE

The invention will be described in further detail with reference to examples, but the invention is not limited thereto.

### Experimental Example 1

### <Blending Process>

As starting materials, SrCO₃, La₂O₃, Fe₂O₃, Co₃O₄, CaCO₃, SiO₂, BaCO₃, Al₂O₃ and Cr₂O₃ were prepared and weighed so that the final composition of the ferrite sintered magnet was the composition of each sample listed in Table 1. In all examples, the position of (Mc, Ms) is one of the positions A to G in FIGS. 1 to 6. According to the examples in which Mc and Ms are the same, the compositions other than Mc and Ms are also all the same.

The above starting materials other than La₂O₃ and Co₃O₄ were mixed and pulverized in a wet attritor to obtain a slurry-like raw material mixture.

### <Preliminary Firing Process>

After drying the raw material mixture, the mixture was preliminary fired in the air at 1200° C.for two hours to obtain a preliminary fired body.

### <Pulverization Process>

The obtained preliminary fired body was coarsely pulverized by a rod mill to obtain a coarsely pulverized material. Next, La₂O₃ and Co₃O₄ were added and finely pulverized with a wet attritor for one hour to obtain a slurry containing finely pulverized powder having an average particle size of one μm. The obtained slurry was adjusted to have a solid content concentration of 70 to 75 mass % to prepare a slurry for the wet pressing.

### <Compacting/Firing Process>

Next, a preliminary green compact was obtained using a wet magnetic field pressing machine. The pressing pressure was 50 MPa and the applied magnetic field was 800 kA/m. The pressurizing direction and the magnetic field application direction during pressing were set to be the same direction. The preliminary compact obtained by wet pressing was disc-shaped and had a diameter of 30 mm. The “Green Compact” column in Table 1 shows the thicknesses.

The preliminary green compact was fired in air at an optimum firing temperature for one hour to obtain a sintered body of a ferrite sintered magnet. The “sintered body (before Processing)” column in Table 1 is the thicknesses of the ferrite sintered body.

Hereinafter, a method for determining the optimum firing temperature in this example will be described below.

First, the compositions of each experimental example were fired from 1190 to 1230° C. changing the temperature every 10° C.to manufacture sintered bodies. That is, a total of five sintered bodies were produced for each experimental example. Then, the density of each sintered body was measured, and the firing temperature of the sintered body with the highest density was taken as the optimum firing temperature. The density of the sintered body was measured by the Archimedes method.

Fluorescent X-ray quantitative analysis was performed on each ferrite sintered magnet, and it was confirmed that each ferrite sintered magnet had the composition shown in Table 1.

It was also confirmed by X-ray diffraction measurement that each ferrite sintered magnet in Table 1 had a hexagonal magnetoplumbite crystal structure.

### <Measurements of Magnetic Properties (Br, HcJ)>

In each experimental example, the upper and lower surfaces of each ferrite sintered magnet obtained by sintering at the optimum firing temperature were processed by grinding using a grinding machine. Table 1 shows the thickness of the ferrite sintered magnet after grinding. After that, the magnetic properties were measured in air atmosphere at 25° C. using a BH tracer with a maximum applied magnetic field of 1989 kA/m. Results are shown in Table 1. According to the Examples, when Br is 400.0 mT or more and HcJ is 320.0 kA/m or more, the magnetic properties are considered to be preferable. It was judged that the magnetic properties were particularly preferable when Br is 410.0 mT or more and HcJ is 335.0 kA/m or more. “After Grinding” column in Table 1 is the thickness of the sintered body after grinding the upper and lower surfaces.

### <Measurement of Dependence on Firing Temperature (ΔHcJ)>

HcJ was measured when firing was performed at the optimal firing temperature−10° C., the optimal firing temperature, and the optimal firing temperature+10° C. respectively. Then, the difference between the maximum value and the minimum value of HcJ was defined as ΔHcJ. The smaller the ΔHcJ. the preferable the production stability. When ΔHcJ was 40.0 kA/m or less. the production stability was judged to be more preferable Further. it was assumed that the production stability was particularly preferable when ΔHcJ was 20.0 k A/m or less.

TABLE 1

| | Thickness (mm) | | | Sr₁₋ₓLaₓ(Fe_{12-y}Co_{y})_{z}O₁₉ | | | | Subcomponent | |
|---|---|---|---|---|---|---|---|---|---|
| Sample | Green | Sintered Body | After | (Atomic Number Ratio) | | | | (mass %) | |
| No. | Compact | (before Grinding) | Grinding | 1 − x | x | (12 − y)z | yz | CaO(Mc) | SiO₂(Ms) |
| 1 | 3.5 | 2.7 | 2.2 | 0.82 | 0.18 | 11.85 | 0.15 | 0.530 | 0.420 |
| 2 | 3.5 | 2.7 | 2.2 | 0.81 | 0.19 | 11.83 | 0.15 | 0.524 | 0.453 |
| 3 | 3.5 | 2.7 | 2.2 | 0.82 | 0.18 | 11.94 | 0.15 | 0.518 | 0.482 |
| 4 | 3.5 | 2.6 | 2.1 | 0.81 | 0.19 | 11.92 | 0.15 | 0.606 | 0.414 |
| 5 | 3.5 | 2.7 | 2.2 | 0.82 | 0.18 | 11.95 | 0.15 | 0.624 | 0.452 |
| 6 | 3.5 | 2.7 | 2.2 | 0.81 | 0.19 | 11.99 | 0.15 | 0.710 | 0.423 |
| 7 | 3.5 | 2.6 | 2.1 | 0.82 | 0.18 | 11.92 | 0.15 | 0.695 | 0.449 |
| 11 | 4.0 | 3.2 | 2.6 | 0.82 | 0.18 | 11.85 | 0.15 | 0.530 | 0.420 |
| 12 | 4.0 | 3.1 | 2.5 | 0.81 | 0.19 | 11.83 | 0.15 | 0.524 | 0.453 |
| 13 | 4.0 | 3.1 | 2.5 | 0.82 | 0.18 | 11.94 | 0.15 | 0.518 | 0.482 |
| 14 | 4.0 | 3.2 | 2.6 | 0.81 | 0.19 | 11.92 | 0.15 | 0.606 | 0.414 |
| 15 | 4.0 | 3.2 | 2.6 | 0.82 | 0.18 | 11.95 | 0.15 | 0.624 | 0.452 |
| 16 | 4.0 | 3.1 | 2.5 | 0.81 | 0.19 | 11.99 | 0.15 | 0.710 | 0.423 |
| 17 | 4.0 | 3.2 | 2.6 | 0.82 | 0.18 | 11.92 | 0.15 | 0.695 | 0.449 |
| 21 | 5.5 | 4.1 | 3.3 | 0.82 | 0.18 | 11.85 | 0.15 | 0.530 | 0.420 |
| 22 | 5.5 | 4.1 | 3.3 | 0.81 | 0.19 | 11.83 | 0.15 | 0.524 | 0.453 |
| 23 | 5.5 | 4.1 | 3.3 | 0.82 | 0.18 | 11.94 | 0.15 | 0.518 | 0.482 |
| 24 | 5.5 | 4.0 | 3.3 | 0.81 | 0.19 | 11.92 | 0.15 | 0.606 | 0.414 |
| 25 | 5.5 | 4.1 | 3.3 | 0.82 | 0.18 | 11.95 | 0.15 | 0.624 | 0.452 |
| 26 | 5.5 | 4.1 | 3.3 | 0.81 | 0.19 | 11.99 | 0.15 | 0.710 | 0.423 |
| 27 | 5.5 | 4.0 | 3.3 | 0.82 | 0.18 | 11.92 | 0.15 | 0.695 | 0.449 |
| 31 | 8.0 | 6.0 | 5.2 | 0.82 | 0.18 | 11.85 | 0.15 | 0.530 | 0.420 |
| 32 | 8.0 | 6.1 | 5.3 | 0.81 | 0.19 | 11.83 | 0.15 | 0.524 | 0.453 |
| 33 | 8.0 | 6.1 | 5.3 | 0.82 | 0.18 | 11.94 | 0.15 | 0.518 | 0.482 |
| 34 | 8.0 | 6.1 | 5.3 | 0.81 | 0.19 | 11.92 | 0.15 | 0.606 | 0.414 |
| 35 | 8.0 | 6.1 | 5.3 | 0.82 | 0.18 | 11.95 | 0.15 | 0.624 | 0.452 |
| 36 | 8.0 | 6.1 | 5.3 | 0.81 | 0.19 | 11.99 | 0.15 | 0.710 | 0.423 |
| 37 | 8.0 | 6.1 | 5.3 | 0.82 | 0.18 | 11.92 | 0.15 | 0.695 | 0.449 |
| 41 | 16.0 | 11.9 | 10.4 | 0.82 | 0.18 | 11.85 | 0.15 | 0.530 | 0.420 |
| 42 | 16.0 | 12.1 | 10.6 | 0.81 | 0.19 | 11.83 | 0.15 | 0.524 | 0.453 |
| 43 | 16.0 | 12.2 | 10.6 | 0.82 | 0.18 | 11.94 | 0.15 | 0.518 | 0.482 |
| 44 | 16.0 | 12.2 | 10.6 | 0.81 | 0.19 | 11.92 | 0.15 | 0.606 | 0.414 |
| 45 | 16.0 | 12.2 | 10.6 | 0.82 | 0.18 | 11.95 | 0.15 | 0.624 | 0.452 |
| 46 | 16.0 | 11.7 | 10.2 | 0.81 | 0.19 | 11.99 | 0.15 | 0.710 | 0.423 |
| 47 | 16.0 | 12.2 | 10.6 | 0.82 | 0.18 | 11.92 | 0.15 | 0.695 | 0.449 |

| Sample | Subcomponent (mass %) | | | Position | Br | HcJ | ΔHcJ |
|---|---|---|---|---|---|---|---|
| No. | BaO(Mb) | Al₂O₃(Ma) | Cr₂O₃(Mr) | of (Mc, Ms) | mT | kA/m | kA/m |
| 1 | 0.100 | 0.069 | 0.044 | A | 414.4 | 340.5 | 18.7 |
| 2 | 0.101 | 0.068 | 0.044 | B | 415.7 | 346.3 | 8.8 |
| 3 | 0.099 | 0.068 | 0.043 | C | 417.1 | 350.7 | 19.4 |
| 4 | 0.097 | 0.068 | 0.043 | D | 417.6 | 335.7 | 19.0 |
| 5 | 0.100 | 0.070 | 0.043 | E | 420.2 | 350.7 | 16.3 |
| 6 | 0.086 | 0.069 | 0.038 | F | 421.1 | 341.2 | 24.4 |
| 7 | 0.096 | 0.068 | 0.042 | G | 414.0 | 350.2 | 15.8 |
| 11 | 0.100 | 0.069 | 0.044 | A | 416.2 | 358.2 | 11.5 |
| 12 | 0.101 | 0.068 | 0.044 | B | 422.7 | 353.1 | 12.9 |
| 13 | 0.099 | 0.068 | 0.043 | C | 422.1 | 353.3 | 21.4 |
| 14 | 0.097 | 0.068 | 0.043 | D | 425.1 | 354.3 | 21.5 |
| 15 | 0.100 | 0.070 | 0.043 | E | 419.5 | 356.1 | 8.5 |
| 16 | 0.086 | 0.069 | 0.038 | F | 416.1 | 349.5 | 10.7 |
| 17 | 0.096 | 0.068 | 0.042 | G | 423.3 | 358.4 | 16.9 |
| 21 | 0.100 | 0.069 | 0.044 | A | 424.2 | 349.2 | 6.0 |
| 22 | 0.101 | 0.068 | 0.044 | B | 420.8 | 355.2 | 29.3 |
| 23 | 0.099 | 0.068 | 0.043 | C | 421.7 | 356.2 | 35.4 |
| 24 | 0.097 | 0.068 | 0.043 | D | 424.0 | 353.0 | 14.3 |
| 25 | 0.100 | 0.070 | 0.043 | E | 422.4 | 359.1 | 8.4 |
| 26 | 0.086 | 0.069 | 0.038 | F | 427.9 | 351.7 | 11.2 |
| 27 | 0.096 | 0.068 | 0.042 | G | 424.7 | 360.8 | 12.3 |
| 31 | 0.100 | 0.069 | 0.044 | A | 435.8 | 355.1 | 11.7 |
| 32 | 0.101 | 0.068 | 0.044 | B | 429.6 | 352.5 | 25.7 |
| 33 | 0.099 | 0.068 | 0.043 | C | 429.7 | 357.8 | 33.1 |
| 34 | 0.097 | 0.068 | 0.043 | D | 427.3 | 361.9 | 5.7 |
| 35 | 0.100 | 0.070 | 0.043 | E | 429.4 | 363.3 | 23.1 |
| 36 | 0.086 | 0.069 | 0.038 | F | 428.6 | 362.7 | 8.1 |
| 37 | 0.096 | 0.068 | 0.042 | G | 427.9 | 367.3 | 3.4 |
| 41 | 0.100 | 0.069 | 0.044 | A | 442.1 | 354.6 | 28.3 |
| 42 | 0.101 | 0.068 | 0.044 | B | 443.0 | 339.1 | 43.7 |
| 43 | 0.099 | 0.068 | 0.043 | C | 441.1 | 362.0 | 42.1 |
| 44 | 0.097 | 0.068 | 0.043 | D | 442.5 | 362.2 | 2.4 |
| 45 | 0.100 | 0.070 | 0.043 | E | 442.9 | 352.4 | 36.4 |
| 46 | 0.086 | 0.069 | 0.038 | F | 441.2 | 367.6 | 4.1 |
| 47 | 0.096 | 0.068 | 0.042 | G | 443.2 | 368.0 | 5.6 |

Table 1 shows that ΔHcJ was 60.0 kA/m or less and the magnetic properties were particularly preferable in all cases in which the thickness of the green compact was 3.5 to 16.0 mm and 0.500≤Mc≤0.710 and 0.410≤Mc≤0.485 were satisfied. Also, ΔHcJ was 40.0 kA/m or less in all cases in which the thickness of the green compact was 3.5 to 8.0 mm.

In the case that the thickness of the green compact was changed without changing the composition, especially Mc and Ms, ΔHcJ was 20.0 kA/m or less when the thickness of the green compact was any one of 3.5 to 8.0 mm regardless of the composition. Specifically, in the case that the position of (Mc, Ms) was A, ΔHcJ was 20.0 kA/m or less when the thickness of the green compact was 3.5 to 8.0 mm. In the case that the position of (Mc, Ms) was B, ΔHcJ was 20.0 kA/m or less when the thickness of the compact was 3.5 to 4.0 mm. In the case that the position of (Mc, Ms) was C, ΔHcJ was 20.0 kA/m or less when the thickness of the green compact was 3.5 mm. In the case that the position of (Mc, Ms) was D, ΔHcJ was 20.0 kA/m or less when the thickness of the green compact was 3.5 mm and 5.5 to 8.0 mm. In the case that the position of (Mc, Ms) was E, ΔHcJ was 20.0 kA/m or less when the thickness of the compact was 3.5 to 5.5 mm. In the case that the position of (Mc, Ms) was F. ΔHcJ was 20.0 kA/m or less when the thickness of the green compact was 4.0 to 8.0 mm. In the case that the position of (Mc, Ms) was G, ΔHcJ was 20.0 kA/m or less when thickness of the green compact was 3.5 to 8.0 mm.

Considering above, when the composition is within a specific range satisfying 0.500≤Mc≤0.710 and 0.410≤Ms≤0.485 and the like, even if the thickness of the green compact is 8.0 mm or less, the production stability can be improved by selecting an appropriate thickness of the green compact.

In the case that 0.500≤Mc≤0.700 and 0.420≤Ms≤0.475 were satisfied, ΔHcJ was always 20.0 kA/m or less when the compact thickness was 3.5 to 4.0 mm, the thickness of the sintered body before processing was 2.6 to 3.2 mm and the thickness of the sintered body after processing was 2.1 to 2.6 mm.

In the case that 0.500≤Mc≤0.710 and 0.410≤Ms≤0.450 were satisfied, ΔHcJ was always 20.0 kA/m or less when the compact thickness was 5.5 to 8.0 mm, the thickness of the sintered compact before processing was 4.0 to 6.1 mm, and the thickness of the sintered compact after processing was 3.3 to 5.3 mm.

### Experimental Example 2

In Experimental Example 2, for each of the samples 2, 12, 32, 7 and 37 in Experimental Example 1, samples in which x, (12−y)z, yz, Mb, Ma or Mr were changed without changing the thickness of the green compact, the thickness of the sintered body before processing, the thickness of the sintered body after processing, and Mc and Ms, were prepared. Br. HcJ and ΔHcJ were measured in the same manner as Experimental Example 1. The results are shown in Tables 2 and 3.

TABLE 2

| | Thickness (mm) | | | Sr₁₋ₓLaₓ(Fe_{12-y}Co_{y})_{z}O₁₉ | | | | Subcomponent | |
|---|---|---|---|---|---|---|---|---|---|
| Sample | Green | Sintered Body | After | (Atomic Number Ratio) | | | | (mass %) | |
| No. | Compact | (before Grinding) | Grinding | 1 − x | x | (12 − y)z | yz | CaO(Mc) | SiO₂(Ms) |
| 101 | 3.5 | 2.7 | 2.2 | 0.86 | 0.14 | 11.83 | 0.15 | 0.524 | 0.453 |
| 2 | 3.5 | 2.7 | 2.2 | 0.81 | 0.19 | 11.83 | 0.15 | 0.524 | 0.453 |
| 102 | 3.5 | 2.7 | 2.2 | 0.78 | 0.22 | 11.83 | 0.15 | 0.524 | 0.453 |
| 103 | 3.5 | 2.7 | 2.2 | 0.81 | 0.19 | 11.60 | 0.15 | 0.524 | 0.453 |
| 104 | 3.5 | 2.7 | 2.2 | 0.81 | 0.19 | 11.99 | 0.15 | 0.524 | 0.453 |
| 105 | 3.5 | 2.7 | 2.2 | 0.81 | 0.19 | 11.83 | 0.13 | 0.524 | 0.453 |
| 106 | 3.5 | 2.7 | 2.2 | 0.81 | 0.19 | 11.83 | 0.17 | 0.524 | 0.453 |
| 107 | 3.5 | 2.7 | 2.2 | 0.81 | 0.19 | 11.83 | 0.15 | 0.524 | 0.453 |
| 108 | 3.5 | 2.7 | 2.2 | 0.81 | 0.19 | 11.83 | 0.15 | 0.524 | 0.453 |
| 109 | 3.5 | 2.7 | 2.2 | 0.81 | 0.19 | 11.83 | 0.15 | 0.524 | 0.453 |
| 110 | 3.5 | 2.7 | 2.2 | 0.81 | 0.19 | 11.83 | 0.15 | 0.524 | 0.453 |
| 111 | 3.5 | 2.7 | 2.2 | 0.81 | 0.19 | 11.83 | 0.15 | 0.524 | 0.453 |
| 112 | 3.5 | 2.7 | 2.2 | 0.81 | 0.19 | 11.83 | 0.15 | 0.524 | 0.453 |
| 113 | 4.0 | 3.1 | 2.5 | 0.86 | 0.14 | 11.83 | 0.15 | 0.524 | 0.453 |
| 12 | 4.0 | 3.1 | 2.5 | 0.81 | 0.19 | 11.83 | 0.15 | 0.524 | 0.453 |
| 114 | 4.0 | 3.1 | 2.5 | 0.78 | 0.22 | 11.83 | 0.15 | 0.524 | 0.453 |
| 115 | 4.0 | 3.1 | 2.5 | 0.81 | 0.19 | 11.60 | 0.15 | 0.524 | 0.453 |
| 116 | 4.0 | 3.1 | 2.5 | 0.81 | 0.19 | 11.99 | 0.15 | 0.524 | 0.453 |
| 117 | 4.0 | 3.1 | 2.5 | 0.81 | 0.19 | 11.83 | 0.13 | 0.524 | 0.453 |
| 118 | 4.0 | 3.1 | 2.5 | 0.81 | 0.19 | 11.83 | 0.17 | 0.524 | 0.453 |
| 119 | 4.0 | 3.1 | 2.5 | 0.81 | 0.19 | 11.83 | 0.15 | 0.524 | 0.453 |
| 120 | 4.0 | 3.1 | 2.5 | 0.81 | 0.19 | 11.83 | 0.15 | 0.524 | 0.453 |
| 121 | 4.0 | 3.1 | 2.5 | 0.81 | 0.19 | 11.83 | 0.15 | 0.524 | 0.453 |
| 122 | 4.0 | 3.1 | 2.5 | 0.81 | 0.19 | 11.83 | 0.15 | 0.524 | 0.453 |
| 123 | 4.0 | 3.1 | 2.5 | 0.81 | 0.19 | 11.83 | 0.15 | 0.524 | 0.453 |
| 124 | 4.0 | 3.1 | 2.5 | 0.81 | 0.19 | 11.83 | 0.15 | 0.524 | 0.453 |
| 125 | 8.0 | 6.1 | 5.3 | 0.86 | 0.14 | 11.83 | 0.15 | 0.524 | 0.453 |
| 32 | 8.0 | 6.1 | 5.3 | 0.81 | 0.19 | 11.83 | 0.15 | 0.524 | 0.453 |
| 126 | 8.0 | 6.1 | 5.3 | 0.78 | 0.22 | 11.83 | 0.15 | 0.524 | 0.453 |
| 127 | 8.0 | 6.1 | 5.3 | 0.81 | 0.19 | 11.60 | 0.15 | 0.524 | 0.453 |
| 128 | 8.0 | 6.1 | 5.3 | 0.81 | 0.19 | 11.99 | 0.15 | 0.524 | 0.453 |
| 129 | 8.0 | 6.1 | 5.3 | 0.81 | 0.19 | 11.83 | 0.13 | 0.524 | 0.453 |
| 130 | 8.0 | 6.1 | 5.3 | 0.81 | 0.19 | 11.83 | 0.17 | 0.524 | 0.453 |
| 131 | 8.0 | 6.1 | 5.3 | 0.81 | 0.19 | 11.83 | 0.15 | 0.524 | 0.453 |
| 132 | 8.0 | 6.1 | 5.3 | 0.81 | 0.19 | 11.83 | 0.15 | 0.524 | 0.453 |
| 133 | 8.0 | 6.1 | 5.3 | 0.81 | 0.19 | 11.83 | 0.15 | 0.524 | 0.453 |
| 134 | 8.0 | 6.1 | 5.3 | 0.81 | 0.19 | 11.83 | 0.15 | 0.524 | 0.453 |
| 135 | 8.0 | 6.1 | 5.3 | 0.81 | 0.19 | 11.83 | 0.15 | 0.524 | 0.453 |
| 136 | 8.0 | 6.1 | 5.3 | 0.81 | 0.19 | 11.83 | 0.15 | 0.524 | 0.453 |

| Sample | Subcomponent (mass %) | | | Position | Br | HcJ | ΔHcJ |
|---|---|---|---|---|---|---|---|
| No. | BaO(Mb) | Al₂O₃(Ma) | Cr₂O₃(Mr) | of (Mc, Ms) | mT | kA/m | kA/m |
| 101 | 0.101 | 0.068 | 0.044 | B | 407.2 | 369.0 | 9.3 |
| 2 | 0.101 | 0.068 | 0.044 | B | 415.7 | 346.3 | 8.8 |
| 102 | 0.101 | 0.068 | 0.044 | B | 423.7 | 324.4 | 11.1 |
| 103 | 0.101 | 0.068 | 0.044 | B | 412.8 | 331.7 | 14.1 |
| 104 | 0.101 | 0.068 | 0.044 | B | 412.2 | 349.1 | 9.2 |
| 105 | 0.101 | 0.068 | 0.044 | B | 406.0 | 329.4 | 15.9 |
| 106 | 0.101 | 0.068 | 0.044 | B | 414.9 | 350.4 | 9.3 |
| 107 | 0.030 | 0.068 | 0.044 | B | 415.5 | 348.0 | 9.4 |
| 108 | 0.150 | 0.068 | 0.044 | B | 405.9 | 346.1 | 9.2 |
| 109 | 0.101 | 0.050 | 0.044 | B | 415.1 | 345.7 | 9.3 |
| 110 | 0.101 | 0.900 | 0.044 | B | 405.9 | 362.4 | 9.9 |
| 111 | 0.101 | 0.068 | 0.030 | B | 416.3 | 343.4 | 9.7 |
| 112 | 0.101 | 0.068 | 0.100 | B | 406.0 | 354.0 | 9.4 |
| 113 | 0.101 | 0.068 | 0.044 | B | 414.5 | 376.2 | 12.7 |
| 12 | 0.101 | 0.068 | 0.044 | B | 422.7 | 353.1 | 12.9 |
| 114 | 0.101 | 0.068 | 0.044 | B | 430.7 | 331.0 | 15.9 |
| 115 | 0.101 | 0.068 | 0.044 | B | 420.1 | 337.9 | 17.2 |
| 116 | 0.101 | 0.068 | 0.044 | B | 418.8 | 356.1 | 13.5 |
| 117 | 0.101 | 0.068 | 0.044 | B | 412.9 | 336.1 | 19.7 |
| 118 | 0.101 | 0.068 | 0.044 | B | 422.0 | 357.4 | 13.9 |
| 119 | 0.030 | 0.068 | 0.044 | B | 422.3 | 354.5 | 13.5 |
| 120 | 0.150 | 0.068 | 0.044 | B | 412.8 | 353.4 | 13.3 |
| 121 | 0.101 | 0.050 | 0.044 | B | 422.0 | 352.3 | 13.3 |
| 122 | 0.101 | 0.900 | 0.044 | B | 413.0 | 369.6 | 14.0 |
| 123 | 0.101 | 0.068 | 0.030 | B | 423.1 | 350.3 | 13.9 |
| 124 | 0.101 | 0.068 | 0.100 | B | 413.0 | 361.1 | 14.0 |
| 125 | 0.101 | 0.068 | 0.044 | B | 421.1 | 376.0 | 23.4 |
| 32 | 0.101 | 0.068 | 0.044 | B | 429.6 | 352.5 | 25.7 |
| 126 | 0.101 | 0.068 | 0.044 | B | 438.0 | 330.2 | 31.3 |
| 127 | 0.101 | 0.068 | 0.044 | B | 426.6 | 337.7 | 34.1 |
| 128 | 0.101 | 0.068 | 0.044 | B | 426.0 | 355.5 | 27.1 |
| 129 | 0.101 | 0.068 | 0.044 | B | 419.3 | 335.5 | 38.5 |
| 130 | 0.101 | 0.068 | 0.044 | B | 428.7 | 356.3 | 27.0 |
| 131 | 0.030 | 0.068 | 0.044 | B | 429.2 | 353.9 | 26.5 |
| 132 | 0.150 | 0.068 | 0.044 | B | 419.6 | 352.8 | 26.6 |
| 133 | 0.101 | 0.050 | 0.044 | B | 428.9 | 351.7 | 26.5 |
| 134 | 0.101 | 0.900 | 0.044 | B | 419.6 | 369.3 | 27.9 |
| 135 | 0.101 | 0.068 | 0.030 | B | 430.3 | 349.8 | 27.4 |
| 136 | 0.101 | 0.068 | 0.100 | B | 419.3 | 360.2 | 27.4 |

TABLE 3

| | Thickness (mm) | | | Sr₁₋ₓLaₓ(Fe_{12-y}Co_{y})_{z}O₁₉ | | | | Subcomponent | |
|---|---|---|---|---|---|---|---|---|---|
| Sample | Green | Sintered Body | After | (Atomic Number Ratio) | | | | (mass %) | |
| No. | Compact | (before Grinding) | Grinding | 1 − x | x | (12 − y)z | yz | CaO(Mc) | SiO₂(Ms) |
| 137 | 3.5 | 2.6 | 2.1 | 0.86 | 0.14 | 11.92 | 0.15 | 0.695 | 0.449 |
| 7 | 3.5 | 2.6 | 2.1 | 0.82 | 0.18 | 11.92 | 0.15 | 0.695 | 0.449 |
| 138 | 3.5 | 2.6 | 2.1 | 0.78 | 0.22 | 11.92 | 0.15 | 0.695 | 0.449 |
| 139 | 3.5 | 2.6 | 2.1 | 0.82 | 0.18 | 11.60 | 0.15 | 0.695 | 0.449 |
| 140 | 3.5 | 2.6 | 2.1 | 0.82 | 0.18 | 11.99 | 0.15 | 0.695 | 0.449 |
| 141 | 3.5 | 2.6 | 2.1 | 0.82 | 0.18 | 11.92 | 0.13 | 0.695 | 0.449 |
| 142 | 3.5 | 2.6 | 2.1 | 0.82 | 0.18 | 11.92 | 0.17 | 0.695 | 0.449 |
| 143 | 3.5 | 2.6 | 2.1 | 0.82 | 0.18 | 11.92 | 0.15 | 0.695 | 0.449 |
| 144 | 3.5 | 2.6 | 2.1 | 0.82 | 0.18 | 11.92 | 0.15 | 0.695 | 0.449 |
| 145 | 3.5 | 2.6 | 2.1 | 0.82 | 0.18 | 11.92 | 0.15 | 0.695 | 0.449 |
| 146 | 3.5 | 2.6 | 2.1 | 0.82 | 0.18 | 11.92 | 0.15 | 0.695 | 0.449 |
| 147 | 3.5 | 2.6 | 2.1 | 0.82 | 0.18 | 11.92 | 0.15 | 0.695 | 0.449 |
| 148 | 3.5 | 2.6 | 2.1 | 0.82 | 0.18 | 11.92 | 0.15 | 0.695 | 0.449 |
| 149 | 8.0 | 6.1 | 5.3 | 0.86 | 0.14 | 11.92 | 0.15 | 0.695 | 0.449 |
| 37 | 8.0 | 6.1 | 5.3 | 0.82 | 0.18 | 11.92 | 0.15 | 0.695 | 0.449 |
| 150 | 8.0 | 6.1 | 5.3 | 0.78 | 0.22 | 11.92 | 0.15 | 0.695 | 0.449 |
| 151 | 8.0 | 6.1 | 5.3 | 0.82 | 0.18 | 11.60 | 0.15 | 0.695 | 0.449 |
| 152 | 8.0 | 6.1 | 5.3 | 0.82 | 0.18 | 11.99 | 0.15 | 0.695 | 0.449 |
| 153 | 8.0 | 6.1 | 5.3 | 0.82 | 0.18 | 11.92 | 0.13 | 0.695 | 0.449 |
| 154 | 8.0 | 6.1 | 5.3 | 0.82 | 0.18 | 11.92 | 0.17 | 0.695 | 0.449 |
| 155 | 8.0 | 6.1 | 5.3 | 0.82 | 0.18 | 11.92 | 0.15 | 0.695 | 0.449 |
| 156 | 8.0 | 6.1 | 5.3 | 0.82 | 0.18 | 11.92 | 0.15 | 0.695 | 0.449 |
| 157 | 8.0 | 6.1 | 5.3 | 0.82 | 0.18 | 11.92 | 0.15 | 0.695 | 0.449 |
| 158 | 8.0 | 6.1 | 5.3 | 0.82 | 0.18 | 11.92 | 0.15 | 0.695 | 0.449 |
| 159 | 8.0 | 6.1 | 5.3 | 0.82 | 0.18 | 11.92 | 0.15 | 0.695 | 0.449 |
| 160 | 8.0 | 6.1 | 5.3 | 0.82 | 0.18 | 11.92 | 0.15 | 0.695 | 0.449 |

| Sample | Subcomponent (mass %) | | | Position | Br | HcJ | ΔHcJ |
|---|---|---|---|---|---|---|---|
| No. | BaO(Mb) | Al₂O₃(Ma) | Cr₂O₃(Mr) | of (Mc, Ms) | mT | kA/m | kA/m |
| 137 | 0.096 | 0.068 | 0.042 | G | 407.8 | 359.5 | 19.1 |
| 7 | 0.096 | 0.068 | 0.042 | G | 414.0 | 350.2 | 15.8 |
| 138 | 0.096 | 0.068 | 0.042 | G | 419.9 | 340.7 | 11.2 |
| 139 | 0.096 | 0.068 | 0.042 | G | 411.1 | 335.2 | 17.1 |
| 140 | 0.096 | 0.068 | 0.042 | G | 410.4 | 352.8 | 16.6 |
| 141 | 0.096 | 0.068 | 0.042 | G | 404.0 | 333.2 | 19.1 |
| 142 | 0.096 | 0.068 | 0.042 | G | 413.6 | 354.1 | 17.0 |
| 143 | 0.030 | 0.068 | 0.042 | G | 413.5 | 351.9 | 16.6 |
| 144 | 0.150 | 0.068 | 0.042 | G | 404.3 | 350.1 | 16.2 |
| 145 | 0.096 | 0.050 | 0.042 | G | 413.3 | 349.7 | 16.4 |
| 146 | 0.096 | 0.900 | 0.042 | G | 404.4 | 367.0 | 17.1 |
| 147 | 0.096 | 0.068 | 0.030 | G | 414.5 | 347.3 | 17.2 |
| 148 | 0.096 | 0.068 | 0.100 | G | 404.5 | 358.2 | 17.0 |
| 149 | 0.096 | 0.068 | 0.042 | G | 421.5 | 377.0 | 4.4 |
| 37 | 0.096 | 0.068 | 0.042 | G | 427.9 | 367.3 | 3.4 |
| 150 | 0.096 | 0.068 | 0.042 | G | 433.8 | 357.4 | 5.2 |
| 151 | 0.096 | 0.068 | 0.042 | G | 424.9 | 351.7 | 5.4 |
| 152 | 0.096 | 0.068 | 0.042 | G | 424.3 | 370.3 | 3.7 |
| 153 | 0.096 | 0.068 | 0.042 | G | 418.0 | 349.7 | 6.3 |
| 154 | 0.096 | 0.068 | 0.042 | G | 427.3 | 371.6 | 3.8 |
| 155 | 0.030 | 0.068 | 0.042 | G | 427.6 | 368.8 | 3.8 |
| 156 | 0.150 | 0.068 | 0.042 | G | 417.6 | 367.3 | 3.5 |
| 157 | 0.096 | 0.050 | 0.042 | G | 427.3 | 366.9 | 3.8 |
| 158 | 0.096 | 0.900 | 0.042 | G | 417.7 | 384.9 | 4.2 |
| 159 | 0.096 | 0.068 | 0.030 | G | 428.5 | 364.4 | 4.0 |
| 160 | 0.096 | 0.068 | 0.100 | G | 417.7 | 375.8 | 3.9 |

From Tables 2 and 3. the magnetic properties were preferable even when the conditions other than Mc and Ms were varied within a predetermined range. In addition. the same results as in Experimental Example 1 were obtained with respect to ΔHcJ.

10: C-shaped green compact

12: Disc-shaped compact

12a: Upper surface

12b: Lower surface

1. A ferrite sintered magnet represented by A₁₋ₓRₓ(Fe_{12-y}Co_{y})_{z}O₁₉ in terms of atomic number ratio, wherein
A is at least one selected from a group consisting of Sr, Ba and Pb,
R is La only or La and at least one selected from a group consisting of Bi and rare earth elements,
0.14≤x≤0.22,
11.60≤(12−y)×z≤11.99, and
0.13≤y×z≤0.17 are satisfied;
0.500≤Mc≤0.710 is satisfied in which Mc is CaO content in mass % converted from a content of Ca included in the ferrite sintered magnet, and
0.410≤Ms≤0.485 is satisfied in which Ms is SiO₂ content in mass % converted from a content of Si included in the ferrite sintered magnet.

2. The ferrite sintered magnet according to claim 1, wherein 0.500≤Mc≤0.700 and 0.420≤Ms≤0.475 are satisfied.

3. The ferrite sintered magnet according to claim 2 having an average thickness of 3.2 mm or less.

4. The ferrite sintered magnet according to claim 1, wherein 0.410≤Ms≤0.450 is satisfied.

5. The ferrite sintered magnet according to claim 4 having an average thickness of 3.3 mm or more and 6.5 mm or less.

6. The ferrite sintered magnet according to claim 1, wherein
0≤Mb≤0.150 is satisfied in which Mb is BaO content in mass % converted from a content of Ba included in the ferrite sintered magnet.

7. The ferrite sintered magnet according to claim 1, wherein
0≤Ma≤0.900 is satisfied in which Ma is Al₂O₃ content in mass % converted from a content of Al included in the ferrite sintered magnet.

8. The ferrite sintered magnet according to claim 1, wherein
0≤Mr≤0.100 is satisfied in which Mr is Cr₂O₃ content in mass % converted from a content of Cr included in the ferrite sintered magnet.

9. The ferrite sintered magnet according to claim 1 obtained by firing a green compact having an average thickness of 3.5 mm or more and 8.0 mm or less.

10. A manufacturing method of the ferrite sintered magnet according to claim 1 comprising a firing process of the green compact having an average thickness of 3.5 mm or more and 8.0 mm or less.
